(19) United States
(12) Patent Application Publication
(10) Pub. No.: US 2011/0275502 A1
(43) Pub. Date: Nov. 10, 2011

(54) ELECTRICALLY CONDUCTIVE MEMBER FOR ELECTROPHOTOGRAPHIC PRINTER APPLICATIONS

(75) Inventors: Wade Eichhorn, Minneapolis, MN (US); Kristian G. Wyrobek, Minneapolis, MN (US); David Winters, Minneapolis, MN (US); Boris Avrushchenko, Minneapolis, MN (US)

(73) Assignee: 7-SIGMA, INC., Minneapolis, MN (US)

(21) Appl. No.: 12/776,568

(22) Filed: May 10, 2010

(51) Int. Cl. F16C 13/00

(52) U.S. Cl. 492/53; 492/59

(57) ABSTRACT

An electrically conductive roller, belt or mat having an elastomer composition comprised of a carbon nanotube rubber composite material. Specifically the invention relates to an electrically conductive roller, belt or mat having an elastomeric material composition comprised of a carbon nanotube silicone rubber composite material utilizing a liquid silicone rubber with very small loadings of carbon nanotubes.

### FIELD OF THE INVENTION

The invention relates to an electrically conductive roller, belt or mat for use in an electrophotographic printer. More particularly, the invention relates to an electrically conductive roller, belt or mat having an elastomeric composition comprised of a carbon nanotube rubber composite material. Specifically the invention relates to an electrically conductive roller, belt or mat having an elastomeric material composition comprised of a carbon nanotube silicone rubber composite material utilizing a liquid silicone rubber with very small loadings of carbon nanotubes. The invention also relates to an electrically conductive roller, belt or mat having an elastomeric rubber composition comprised of a carbon nanotube rubber composite material member affixed to an electrically conductive thermal plastic member.

### BACKGROUND OF THE INVENTION

Laser printers, and other electrophotographic image forming devices, for both black-and-white and color printing technologies, use toner particles to form a desired image on print media. The print media is often paper, although a wide variety of different print media may be employed. The toner has electrostatic and thermal properties. Those properties are managed in the imaging, transport and fixing of the image to the print media. Material properties of rollers or belts used to transfer, transport and fix the desired image, are critical to the printing process. Of importance are the electrical and surface release properties of the composite materials to hold and release toner particles as desired in an application, as well as dissipate undesirable electrostatic charges. Toner may be transferred to or from an electrophotographic drum or belt, and to a print media or an intermediate conductive member, by the use of a charge transfer roller or belt. Once the toner image is transferred to the final desired media, the media is advanced along a media path, which may employ a belt or mat, to a thermal fuser. In some image forming devices, the fusing system includes a fuser roller or belt and a mating pressure roller. As the media passes between the fuser roller and the pressure roller, the toner is fused to the media through a process using pressure and heat exceeding 300° F. (148° C.).

### SUMMARY OF THE INVENTION

The composite material properties of a charge transfer system roller or belt, a fusing system roller or belt, and a transport mat or belt, are chosen to meet the printer design specifications. The electrical properties of a member, electrically conductive or dissipative, may be of design importance. Therefore, it is desirable to develop a roller, belt or mat having material composition that provides the necessary electrical, thermal and other desired physical properties for the application. Many charge transfer roller used in the laser imaging process for toner transfer, have electrical resistivity values ranging from 10¹¹ Ohm (Ω) cm through 10⁶ Ωcm. A mat or roller with electrical dissipative properties can have a desired electrical resistivity value down to 10³ Ωcm range. The loadings of electrically conductive materials, such as carbon black, utilized to achieve desired resistive values in an elastic polymer member, is normally on the order of greater than 10% by weight. The large loadings of electrically conductive material additives, such as carbon black, have significant diluent affect on desired physical properties such as hardness and elasticity.

The recent commercialization of carbon nanotubes has prompted investigations into using carbon nanotubes as an additive to polymers to confer desired physical properties. One such property is electrical conductivity. It has been noted in the research literature that small amounts of carbon nanotubes increase the conductivity significantly. For the purpose of the invention, a study was conducted using low loadings, less than 10%, of carbon nanotubes in elastomeric rubber polymers. The resultant data also concluded that desirable electrical properties were conferred to silicone rubber with less than 2%, loadings of multi-walled carbon nanotubes. In addition, the study showed that the physical properties of the base elastomer were maintained, and that no diluent behavior was observed. Further, the study showed that uniform resistivity was achieved throughout the carbon nanotube rubber composite. Measurements were made across large surfaces, using conventional measurement techniques, and at the micron level using nanoindentation techniques. These conclusions support the idea that a carbon nanotube rubber composite can effectively be used as electrophotographic printer members requiring electrical properties, in a wide range of products, while maintaining other desirable physical properties such as tensile strength, elongation to break, compression set and hardness. In particular, the study showed that a silicone can infer desired electrical properties with the addition of very low loadings of carbon nanotubes while maintaining the desired physical properties of the original base material.

The design of rollers, belts, or mats used in electrophotographic printing systems employ a single polymer or a multiple layer configuration on a core or substrate. Often polymers are filled with materials, such as carbon black, to infer electrical properties to the polymer. Also fluoropolymer and other thermal plastic materials, such PFA (Perfluoroalkoxy), may be bonded to a material for enhanced toner interaction.

The electrical properties of a material may also be enhanced by the addition of carbon nanotubes, forming a composite polymer material. It has been shown by the inventors that a small amount of carbon nanotube additive results in electrical properties which are favorable for use as an electrically conductive and or dissipative member of an electrophotographic printer, while preserving other desired physical properties of the original base material. It has also been shown by the inventors that bonding of a fluoropolymer, or other thermal plastic member, provides release properties that are desirable of a roller, belt or mat member of an electrophotographic printer. The selection of base rubber materials may be chosen from silicone, EPDM, FKM, urethane and other elastomeric rubber polymers. Furthermore, foam structures of these same materials may be utilized. The selection of thermal plastic materials may be chosen from various classes of fluorocarbons, such as Teflon® (PFA, FEP, PTFE etc.), Polyimide, Kapton® and others.

To achieve desired electrical properties of materials, addition of high percentages, greater than 10% by weight, of electrical conductive additives, such as carbon black, often result in compromised physical properties such as hardness, tensile, and release. The addition of small amounts, less than 10% by weight, of carbon nanotubes increases the electrical conductivity of the base material while preserving the desired physical properties of the original polymer. In addition, bonding a thermal plastic material, such as an electrically conductive PFA, to the carbon nanotube composite, gives further depth of application in electrophotographic printing systems requiring an electrically conductive member.

The low loading of carbon nanotubes to a base polymer preserve desired physical properties such as hardness, tensile, elongation and compression set. Low loadings, by weight, of carbon nanotubes added to a base rubber polymer, significantly changes the electrical properties. For example, a loading of 7%, by weight, of carbon nanotubes dispersed into an EPDM rubber conferred an electrical resistivity of 10⁵ Ωcm. In yet another example, a very low loading of 1% of multi-walled carbon nanotubes dispersed into a liquid silicone rubber, changed the resistivity from 10¹⁴ Ωcm to 10³ Ωcm, with no significant change in the other important physical properties of the original material. In addition, the carbon nanotube silicone rubber composite polymer was then be bonded to an electrically conductive thermal plastic material, such as PFA, having the same resistivity of the carbon nanotube composite material, with no diluent effect on the strength of the interfacial bond between the two materials.

Conventional static and dynamic properties testing of materials, such as tensile, elongation, compression set, surface resistivity, etc., are often used to characterize material properties. Values from these tests are often considered in the choice of materials suitable for applications in charge transfer, transport, and fusing systems members. In addition, novel testing methods such as nanoelectrical contact resistance (nanoECR®), may be employed to further convey and define the characterization of physical properties.

In view of the foregoing, a roller, belt, or mat of the present invention utilizing a carbon nanotube rubber composite elastomeric polymer member, and the carbon nanotube rubber composite elastomeric polymer member bonded to a thermoplastic member, provides a unique and novel design for printer components requiring electrically conductive properties.

The present invention encompasses an electrically conductive roller, belt, or mat composed of a carbon nanotube rubber composite having a loading, by weight, of between 0.1% to 10% carbon nanotubes, and having an electrical resistivity value of 10¹² Ωcm through 10⁻¹ Ωcm. The polymer base of the carbon nanotube rubber composite may be a material chosen from an elastomeric polymer of silicone rubber, EPDM rubber, FKM rubber, urethane rubber and other rubber elastomeric polymers. Specifically, the present invention encompasses an electrically conductive roller, belt, or mat composed of a carbon nanotube silicone rubber composite polymer having a loading, by weight, of between 0.1% to 3% carbon nanotubes, and having an electrical resistivity value of 10¹² Ωcm through 10⁻¹ Ωcm. The present invention also encompasses a roller, belt, or mat, composed of a carbon nanotube rubber composite polymer having a loading, by weight, of between 0.1% to 10% carbon nanotubes and having an electrical resistivity value of 10¹² Ωcm through 10⁻¹ Ωcm or less, onto which is affixed a fluoropolymer thermal plastic member, such as PFA. Specifically, the present invention encompasses an electrically conductive roller, belt or mat comprised of a carbon nanotube silicone rubber composite with a loading of 0.1% to 3% multi-walled carbon nanotubes, to which is affixed a fluoropolymer thermal plastic member such as PFA.

In another embodiment, the invention includes a roller having a core and a base. The base has an inside diameter and an outside diameter, wherein the inside diameter is molded about the core. The roller base is fabricated of a rubber elastomer having a loading of carbon nanotubes, by weight, of between 0.1% and 10%.

In yet another embodiment, the invention includes a roller having a core and base. The base has an inside diameter and an outside diameter, wherein the inside diameter is molded about the core. The roller base is fabricated of a rubber elastomer having a loading of carbon nanotubes, by weight, of between 0.1% and 10%. A top coat is disposed about the entire outside diameter. The top coat is fabricated of fluoropolymer having an electrical resistive value less than, equal to, or greater than the composite rubber.

In another embodiment, the invention includes an electrically conductive belt comprised of a thermal plastic or metal core and an electrically conductive rubber base. The base has an inside diameter and an outside diameter, wherein the electrically conductive rubber base, having a loading of carbon nanotubes, by weight, of between 0.1% and 10%, is molded onto the core.

In yet another embodiment, the invention includes an electrically conductive belt having a thermal plastic or metal core and having an electrically conductive rubber base. The base has an inside diameter and an outside diameter, wherein a rubber elastomer having a loading of carbon nanotubes, by weight, of between 0.1% and 10%, is molded or otherwise adhered onto the core. Affixed to the carbon nanotube composite rubber is a top coat fabricated of a fluoropolymer having an electrical resistive value less than, equal to, or greater than the carbon nanotube composite rubber.

In another embodiment, the invention includes a mat having a base comprised of a carbon nanotube rubber composite elastomeric member, having a loading of carbon nanotubes, by weight, of between 0.1% and 10%. Affixed to the carbon nanotube rubber composite is a top coat fabricated of a fluoropolymer having an electrical resistive value less than, equal to or greater than the carbon nanotube rubber composite.

In yet another embodiment, the invention includes a mat having a base comprised of carbon nanotube rubber composite elastomer having a loading of carbon nanotubes, by weight, of between 0.1% and 10%. Affixed to one side of the carbon nanotube silicone rubber composite is a top coat fabricated of fluoropolymer having an electrical resistive value less, equal to or greater than the composite rubber. Affixed to a second side of the carbon nanotube rubber composite is a bottom surface of metal.

In view of the foregoing, the carbon nanotube rubber composite elastomer may be comprised of single-walled carbon nanotubes and/or multi-walled carbon nanotubes, to infer the desired electrical conductivity or resistivity to the polymer. In view of the foregoing, the carbon nanotube rubber composite may be comprised of materials chosen from a silicone rubber, an EPDM rubber, an FKM rubber, a urethane rubber or other elastomeric polymers common to printer applications. Specifically, in view of the foregoing, the carbon nanotube rubber composite elastomer may be comprised of a silicone rubber chosen from a liquid silicone rubber (LSR), a high consistency rubber (HCR), or a room temperature vulcanized rubber (RTV). More specifically in view of the foregoing, a platinum cured liquid silicone rubber with a loading of multi-walled carbon nanotubes, by weight, of between 0.1% and 3% is the preferred elastomeric composite in the embodiment of this invention.

The present invention encompasses a roller, belt, or mat composed of an elastomeric carbon nanotube composite polymer having a loading, by weight, of between 0.1% to 10% carbon nanotubes and having an electrical resistivity value of 10¹² Ωcm through 10⁻¹ Ωcm or less.

In another embodiment, the present invention encompasses a roller, belt, or mat composed of an elastomeric carbon nanotube composite polymer having a loading, by weight, of between 0.1% to 10% carbon nanotubes and having an electrical resistivity value of 10¹² Ωcm through 10⁻¹ Ωcm or less. The carbon nanotube composite elastomer may be comprised of single-walled carbon nanotubes and/or multi-walled carbon nanotubes to infer the desired electrically conductivity or resistivity to the polymer.

In yet another embodiment, the present invention encompasses a roller, belt, or mat composed of a carbon nanotube composite polymer having a loading, by weight, of between 0.1% to 10% carbon nanotubes and having an electrical resistivity value of 10¹² Ωcm through 10⁻¹ Ωcm or less. The polymer base of the carbon nanotube composite may be a material chosen from an elastomeric polymer of silicone, EPDM, FKM, urethane and other rubber elastomeric polymers.

In yet another embodiment, the present invention encompasses a roller, belt, or mat composed of a carbon nanotube silicone rubber composite polymer having a loading, by weight, of between 0.1% to 3% carbon nanotubes and having an electrical resistivity value of 10¹² Ωcm through 10⁻¹ Ωcm or less. The silicone polymer base of the carbon nanotube composite may be a material chosen from a liquid silicone platinum cured rubber, a high consistency rubber (platinum and peroxide cured), or a room temperature vulcanized silicone rubber.

In yet another embodiment, the present invention encompasses a roller, belt, or mat composed of multi-walled carbon nanotube platinum cured liquid silicone composite rubber having a loading, by weight, of between 0.1% to 3% carbon nanotubes and having an electrical resistivity value of 10¹² Ωcm through 10⁻¹ Ωcm or less.

In yet another embodiment, the present invention encompasses a roller, belt, or mat, composed of a carbon nanotube rubber composite polymer, having an electrical resistivity value of 10¹² Ωcm through 10⁻¹ Ωcm or less, onto which is affixed a thermal plastic member. The selection of thermal plastic materials may be chosen from PFA, FEP, PTFE, Polyimide, Kapton and others.

In yet another embodiment, the present invention encompasses a roller, belt, or mat composed of a carbon nanotube silicone rubber composite polymer having a loading, by weight, of between 0.1% to 3% carbon nanotubes and having an electrical resistivity value of 10¹² Ωcm through 10⁻¹ Ωcm or less. The silicone rubber polymer base of the carbon nanotube composite may be a material chosen from a liquid silicone platinum cured rubber, a peroxide heat cured rubber, or a room temperature vulcanized silicone rubber. Affixed to the base carbon nanotube silicone composite is a thermal plastic member. The selection of thermal plastic materials may be chosen from PFA, FEP, PTFE, Polyimide, Kapton and others.

In yet another embodiment, the present invention encompasses a roller, belt, or mat composed of a carbon nanotube platinum cured liquid silicone rubber composite polymer having a loading, by weight, of between 0.1% to 3% carbon nanotubes and having an electrical resistivity value of 10¹² Ωcm through 10⁻¹ Ωcm or less. Affixed to the base carbon nanotube platinum cured liquid silicone rubber composite is a thermal plastic member. The selection of thermal plastic materials may be chosen from PFA, FEP, PTFE, Polyimide, Kapton and others. The selection of thermal plastic materials may have an electrical resistivity less than, equal to, or greater than the carbon nanotube platinum cured liquid silicone rubber composite polymer to which it is affixed.

In yet another embodiment, the invention includes a roller having a core and a base. The base has an inside diameter and an outside diameter, wherein the inside diameter is molded about the core. The roller base is fabricated of an elastomeric carbon nanotube composite rubber having an electrical resistivity value of 10¹² Ωcm through 10⁻¹ Ωcm or less.

In yet another embodiment, the invention includes a roller having a core and base. The base has an inside diameter and an outside diameter, wherein the inside diameter is molded about the core. The roller base is fabricated of an elastomeric carbon nanotube composite rubber having an electrical resistivity value of 10¹² Ωcm through 10⁻¹ Ωcm or less. A top coat is disposed about the entire outside diameter. The top coat is fabricated of fluoropolymer, or other thermal plastic, having an electrical resistive value less than, equal to, or greater than the carbon nanotube composite rubber.

In yet another embodiment, the present invention encompasses a roller having a core and a base. The base has an inside diameter and an outside diameter, wherein the inside diameter is molded about the core. The roller base is fabricated of a carbon nanotube silicone rubber composite polymer having a loading, by weight, of between 0.1% to 3% carbon nanotubes and having an electrical resistivity value of 10¹² Ωcm through 10⁻¹ Ωcm or less. The silicone polymer base of the carbon nanotube composite may be a material chosen from a liquid silicone platinum cured rubber, a peroxide heat cured rubber, or a room temperature vulcanized silicone rubber.

In yet another embodiment, the invention encompasses a roller having a core and a base. The base has an inside diameter and an outside diameter, wherein the inside diameter is molded about the core. The roller base is fabricated of a carbon nanotube platinum cured liquid silicone rubber composite polymer having a loading, by weight, of between 0.1% to 3% multi-walled carbon nanotubes and having an electrical resistivity value of 10¹² Ωcm through 10⁻¹ Ωcm or less. Affixed to the base carbon nanotube platinum cured liquid silicone rubber composite, is a thermal plastic member. The selection of thermal plastic materials may be chosen from PFA, FEP, PTFE, Polyimide, Kapton and others. The selection of thermal plastic materials may have an electrical resistivity less than, equal to, or greater than the carbon nanotube platinum cured liquid silicone rubber composite polymer to which it is affixed.

In yet another embodiment, the invention includes an electrically conductive belt comprised of a thermal plastic or metal core and a carbon nanotube composite rubber base. The base has an inside diameter and an outside diameter, wherein a rubber elastomer having a loading of carbon nanotubes, having an electrical resistivity value of between 10¹² Ωcm through 10⁻¹ Ωcm or less, is molded or adhered onto the outside diameter of the core. The core may have an electrical resistive value less than, equal to, or greater than the carbon nanotube composite rubber.

In yet another embodiment, the invention includes an electrically conductive belt comprised of a thermal plastic or metal core and a carbon nanotube composite rubber base. The base has an inside diameter and an outside diameter, wherein a conductive carbon nanotube rubber elastomer, is molded or adhered onto the core. The base is fabricated of a carbon nanotube silicone rubber composite polymer having a loading, by weight, of between 0.1% to 3% carbon nanotubes and having an electrical resistivity value of 10¹² Ωcm through 10⁻¹ Ωcm or less. The silicone polymer base of the carbon nanotube composite may be a material chosen from a liquid silicone platinum cured rubber, a peroxide heat cured rubber, or a room temperature vulcanized silicone rubber.

In yet another embodiment, the present invention encompasses an electrically conductive belt comprised of a thermal plastic or metal core and a carbon nanotube composite rubber base. The base has an inside diameter and an outside diameter, wherein the inside diameter is molded or adhered about the core. The base is fabricated of a carbon nanotube platinum cured liquid silicone rubber composite polymer having a loading, by weight, of between 0.1% to 3% of multi-walled carbon nanotubes, and having an electrical resistivity value of 10¹² Ωcm through 10⁻¹ Ωcm or less.

In yet another embodiment, the invention includes an electrically conductive belt comprised of a thermal plastic or metal core and a carbon nanotube composite rubber base. The base has an inside diameter and an outside diameter, wherein the inside diameter is molded or adhered about the core. The base is fabricated of a carbon nanotube rubber composite polymer having an electrical resistivity value of 10¹² Ωcm through 10⁻¹ Ωcm or less. Affixed to the base carbon nanotube rubber composite base, is a thermal plastic member. The selection of thermal plastic materials may be chosen from PFA, FEP, PTFE, for the purpose of enhanced toner release properties. The selection of thermal plastic materials may have an electrical resistivity less than, equal to, or greater than the carbon nanotube platinum cured liquid silicone rubber composite polymer to which it is affixed.

In yet another embodiment, the invention encompasses an electrically conductive belt comprised of a thermal plastic or metal core and a carbon nanotube composite rubber base. The base has an inside diameter and an outside diameter, wherein the inside diameter is molded or adhered about the core. The base is fabricated of a carbon nanotube silicone rubber composite polymer having a loading, by weight, of between 0.1% to 3% of multi-walled carbon nanotubes, and having an electrical resistivity value of 10¹² Ωcm through 10⁻¹ Ωcm or less. The silicone polymer base of the carbon nanotube composite may be a material chosen from a liquid silicone platinum cured rubber, a peroxide heat cured rubber, or a room temperature vulcanized silicone rubber. Affixed to the base is a thermal plastic member. The selection of thermal plastic materials may be chosen from fluoropolymers such as PFA, FEP, PTFE, and others for the purpose of enhanced toner release properties. The selection of thermal plastic materials may have an electrical resistivity less than, equal to, or greater than the carbon nanotube silicone rubber composite polymer to which it is affixed.

In yet another embodiment, the invention encompasses an electrically conductive belt comprised of a thermal plastic or metal core and a carbon nanotube composite rubber base. The base has an inside diameter and an outside diameter, wherein the inside diameter is molded or adhered about the core. The base is fabricated of a carbon nanotube platinum cured liquid silicone rubber composite polymer having a loading, by weight, of between 0.1% to 3% of multi-walled carbon nanotubes, and having an electrical resistivity value of 10¹² Ωcm through 10⁻¹ Ωcm or less. Affixed to the base is a thermal plastic member. The selection of thermal plastic materials may be chosen from fluoropolymers such as PFA, FEP, PTFE, and others for the purpose of enhanced toner release properties. The selection of thermal plastic materials may have an electrical resistivity less than, equal to, or greater than the carbon nanotube platinum cured liquid silicone rubber composite polymer to which it is affixed.

In yet another embodiment, the invention includes a mat having a base comprised of a carbon nanotube rubber composite elastomer having an electrical resistivity value of 10¹² Ωcm through 10⁻¹ Ωcm or less. The invention further includes a mat having a base comprised of a carbon nanotube rubber composite elastomer having a loading of carbon nanotubes having an electrical resistivity value of 10¹² Ωcm through 10⁻¹ Ωcm or less. Affixed to the carbon nanotube rubber composite is a top coat fabricated of thermal plastic fluoropolymer, such as PFA, PFE, PTFE and others, and having an electrical resistive value less than, equal to or greater than the composite rubber.

The invention includes a mat having a base comprised of a carbon nanotube silicone rubber composite polymer having a loading, by weight, of between 0.1% to 3% of carbon nanotubes, and having an electrical resistivity value of 10¹² Ωcm through 10⁻¹ Ωcm or less. Affixed to one side of the carbon nanotube silicone rubber composite is a top coat fabricated of thermal plastic fluoropolymer having an electrical resistive value less, equal to or greater than the composite rubber.

The invention includes a mat having a base comprised of a carbon nanotube platinum cured liquid silicone rubber composite polymer having a loading, by weight, of between 0.1% to 3% of multi-walled carbon nanotubes, and having an electrical resistivity value of 10¹² Ωcm through 10⁻¹ Ωcm or less. Affixed to one side of the carbon nanotube rubber composite is a top coat fabricated of thermal plastic fluoropolymer having an electrical resistive value less, equal to or greater than the composite rubber.

The invention includes a mat having a base comprised of carbon nanotube rubber composite elastomer having an electrical resistivity value of 10¹² Ωcm through 10⁻¹ Ωcm or less.

Affixed to one side of the carbon nanotube rubber composite is a top coat fabricated of thermal plastic fluoropolymer having an electrical resistive value less, equal to or greater than the composite rubber. Affixed to a second side of the carbon nanotube rubber composite is a bottom coat of metal, such as aluminum, copper or steel.

In yet another embodiment, the invention includes a mat having a base comprised of carbon nanotube rubber composite elastomer comprised of a carbon nanotube silicone rubber composite polymer having a loading, by weight, of between 0.1% to 3% of carbon nanotubes, and having an electrical resistivity value of 10¹² Ωcm through 10⁻¹ Ωcm or less. Affixed to one side of the carbon nanotube silicone rubber composite is a top coat fabricated of thermal plastic fluoropolymer having an electrical resistive value less, equal to or greater than the composite rubber. Affixed to a second side of the carbon nanotube rubber composite is a bottom coat of metal, such as aluminum, copper or steel.

In an alternative embodiment, the invention includes a mat having a base comprised of a carbon nanotube platinum cured liquid silicone rubber composite polymer having a loading, by weight, of between 0.1% to 3% of multi-walled carbon nanotubes, and having an electrical resistivity value of 10¹² Ωcm through 10⁻¹ Ωcm or less. Affixed to one side of the carbon nanotube rubber composite is a top coat fabricated of thermal plastic fluoropolymer having an electrical resistive value less, equal to or greater than the composite rubber. Affixed to a second side of the carbon nanotube rubber composite is a bottom coat of metal, such as aluminum, copper or steel.

### BRIEF DESCRIPTION OF THE DRAWINGS

FIG. 1 is a table of physical properties of carbon nanotube liquid silicone rubber composites samples used for a roller, belt or mat base elastomeric polymer according to the invention.

FIG. 2 is a table of physical properties of a sample carbon nanotube EPDM composite rubber used for a roller, belt, or mat base elastomeric polymer according to the invention.

FIG. 3 is a graph of the electrical resistivity property of carbon nanotube liquid silicone composites used for a roller, belt or mat base elastomeric polymer according to the invention.

FIG. 4 is a graph of the nano electrical contact resistance values of carbon nanotube liquid silicone rubber composites samples used for a roller, belt or mat base elastomeric polymer according to the invention.

FIG. 5 is a cross sectional view of an electrically conductive roller according to the present invention.

FIG. 6 is a cross sectional view of an alternative embodiment of an electrically conductive roller according to the present invention.

FIG. 7 is a cross sectional view of an electrically conductive belt according to the present invention.

FIG. 8 is a cross sectional view of an alternative embodiment of an electrically conductive belt according to the present invention.

FIG. 9 is a cross sectional view of an alternative embodiment of an electrically conductive belt according to the present invention.

FIG. 10 is a cross sectional view of an electrically conductive mat according to the present invention.

FIG. 11 is a cross sectional view of an alternative embodiment of an electrically conductive roller according to the present invention.

### DETAILED DESCRIPTION OF THE DRAWINGS

The present invention encompasses the application of carbon nanotube rubber composites as applied to electrically conductive members of a printer, in which the composite is comprised of an elastomeric polymer with loadings between 0.1% and 10% carbon nanotubes. More specifically the present invention encompasses the application of carbon nanotube rubber composite as applied to electrically conductive members of a printer, in which the composite is comprised of a platinum cured liquid silicone rubber with very low loadings between 0.1% and 3%. The figures provide supporting data and design of applications embodied in the present invention.

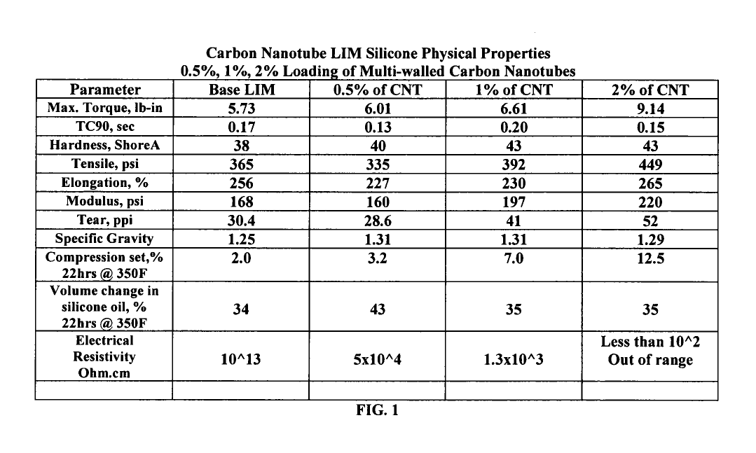

FIG. 1 is a table showing important physical properties of carbon nanotube liquid silicone rubber composites for a conductive roller, belt or mat composition according to the invention. The table shows those properties of materials composed of a base platinum cured liquid silicone rubber loaded with concentrations of 0.5%, 1% and 2% multi-walled carbon nanotubes. The present invention incorporates the properties given in FIG. 1.

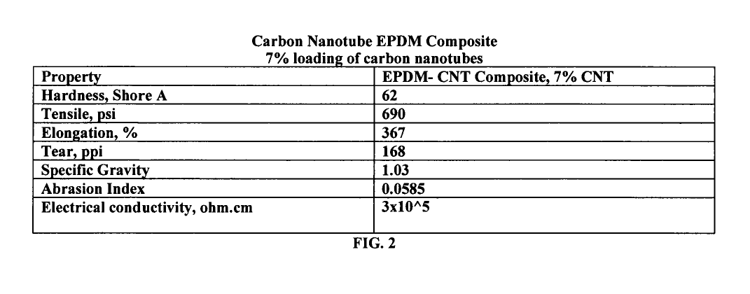

FIG. 2 is a table showing important physical properties of a carbon nanotube EPDM rubber composite with a loading of 7% multi-walled carbon nanotubes. The present invention incorporates the properties given in FIG. 2.

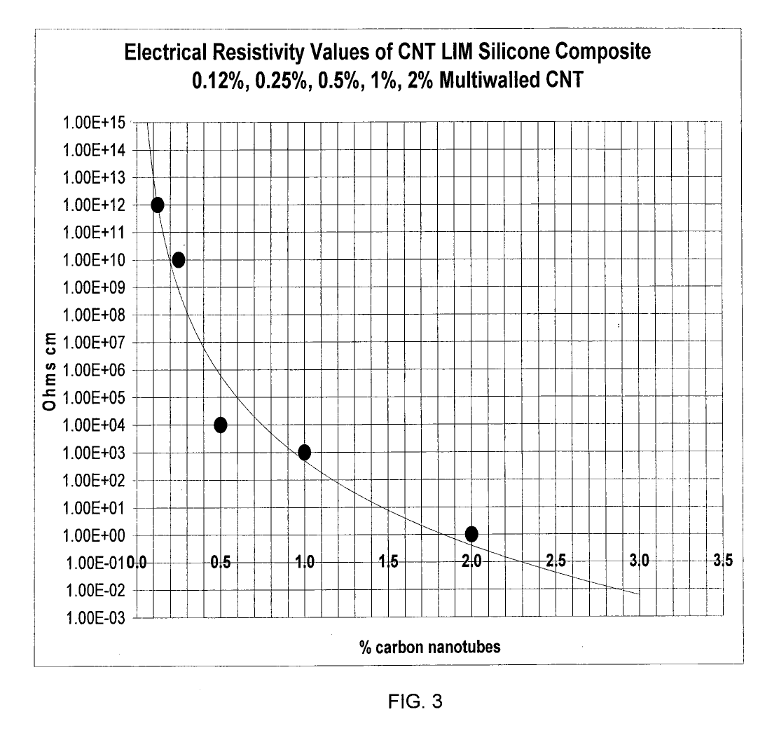

FIG. 3 is a graph showing the electrical resistivity properties of several carbon nanotube liquid silicone composites. Loadings of 0.12%, 0.25%, 0.5%, 1.0% and 2.0% of multi-walled carbon nanotubes were added to a base of platinum cured liquid silicone rubber given in FIG. 1. The resultant electrical resistivity values, measured in Ohms cm, are plotted. The dramatic drop in electrical resistivity with very low loadings of carbon nanotubes is evident. The present invention incorporates the electrical resistivity properties given in FIG. 3 for a roller, belt or mat base elastomeric nanotube composite polymer.

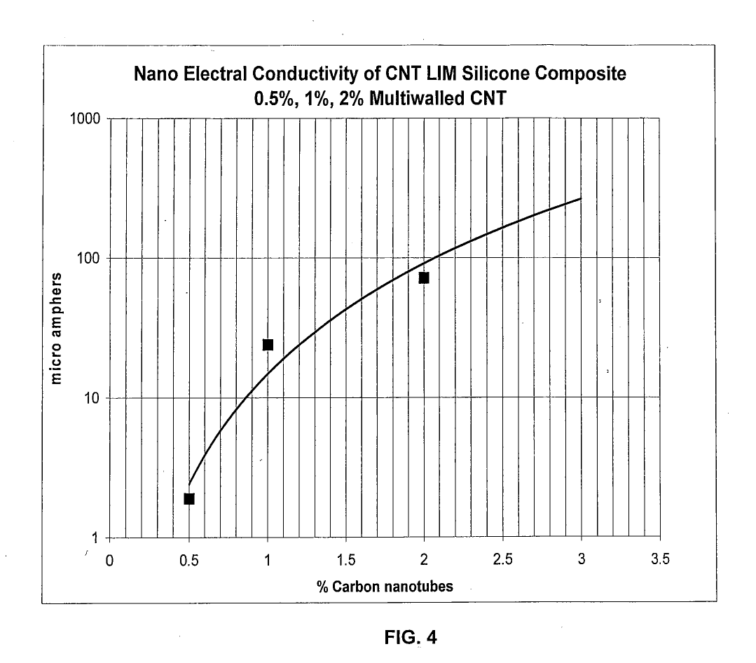

FIG. 4 is a graph of the nanoindentation electrical conductivity, measured over a 10 micron area, of several carbon nanotube liquid silicone composites. Nanoelectrical current values, measured in micro amperes, verses percent carbon nanotube loading values, are plotted. The dramatic increase in electrical current conduction with the addition of very low loadings (0.5%, 1.0%, and 2%) of multi-walled carbon nanotubes is evident. The present invention incorporates the nanoelectrical conductivity properties given in FIG. 4 for a roller, belt or mat elastomeric carbon nanotube composite polymer.

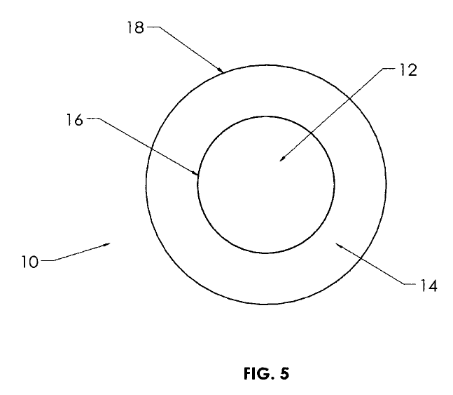

With reference to FIG. 5, the details of one embodiment of an electrically conductive roller are discussed. FIG. 5 is a cross sectional view of an electrically conductive roller according to the present invention. FIG. 5 shows roller 10 which includes a core 12 and a base 14. Base 14 is molded around core 12 and is defined by an inside diameter 16 and an outside diameter 18. Base 14 is fabricated of an electrically conductive elastomer comprised of a base rubber with a loading of carbon nanotube of between 0.1% and 10%. More specifically, base 14 is fabricated of an electrically conductive elastomer comprised of a base liquid silicone rubber with a loading of multi-walled carbon nanotubes of between 0.1% and 3%.

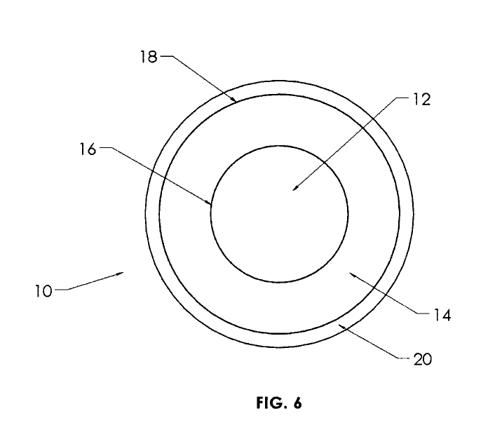

FIG. 6 is a cross sectional view of an alternative embodiment of an electrically conductive roller according to the present invention. FIG. 6 shows roller 10 which includes a core 12 and a base 14. Base 14 is molded around core 12 and is defined by an inside diameter 16 and an outside diameter 18. Base 14 is fabricated of an electrically conductive elastomer comprised of a base rubber with a loading of carbon nanotube of between 0.1% and 10%. More specifically, base 14 is fabricated of an electrically conductive elastomer comprised of a base liquid silicone rubber with a loading of multi-walled carbon nanotubes of between 0.1% and 3%. Top coat 20 is a thermal plastic member affixed to base 14. Examples of a thermal plastic member may be a fluoropolymer, such as PFA, FEP, and PTFE.

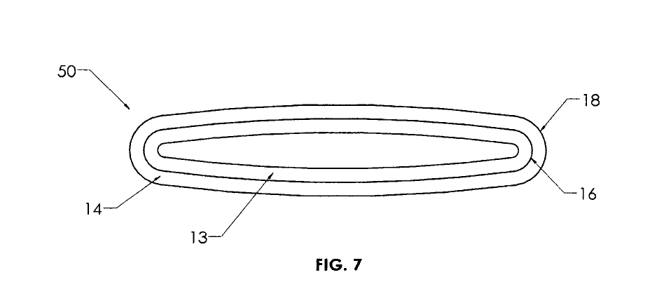

With reference to FIG. 7, the details of one embodiment of an electrically conductive belt are discussed. FIG. 7 is a cross sectional view of an electrically conductive belt according to the present invention. FIG. 7 shows belt 50 which include a core 13 and a base 14. Base 14 is affixed around core 13 and is defined by an inside diameter 16 and an outside diameter 18. Base 14 is fabricated of an electrically conductive elastomer comprised of a base rubber with a loading of carbon nanotube of between 0.1% and 10%. More specifically, base 14 is fabricated of an electrically conductive elastomer comprised of a base liquid silicone rubber with a loading of multi-walled carbon nanotubes of between 0.1% and 3%.

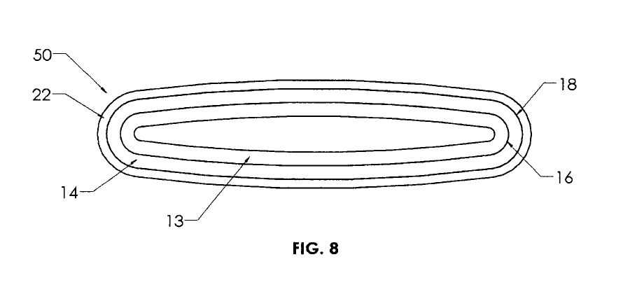

FIG. 8 is a cross sectional view of an alternative embodiment of an electrically conductive belt according to the present invention. FIG. 8 shows belt 50 which include a core 13 and a base 14. Base 14 is affixed around core 13 and is defined by an inside diameter 16 and an outside diameter 18. Base 14 is fabricated of an electrically conductive elastomer comprised of a base rubber with a loading of carbon nanotube of between 0.1% and 10%. More specifically, base 14 is fabricated of an electrically conductive elastomer comprised of a base liquid silicone rubber with a loading of multi-walled carbon nanotubes of between 0.1% and 3%. Top coat 22 is a thermal plastic member affixed to base 14. Examples of a thermal plastic member may be a fluoropolymer, such as PFA, FEP, and PTFE.

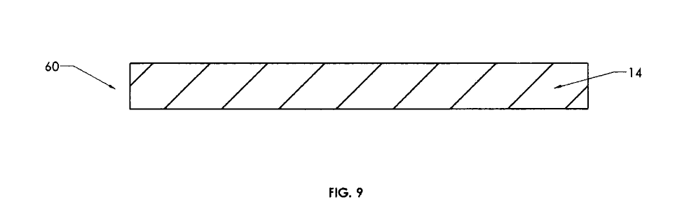

FIG. 9 is a cross sectional view of an electrically conductive mat according to the present invention. FIG. 9 shows a mat 60 comprised of a rubber 14 with a loading of carbon nanotube of between 0.1% and 10%. More specifically, rubber 14 is fabricated of an electrically conductive elastomer comprised of a base liquid silicone rubber with a loading of multi-walled carbon nanotubes of between 0.1% and 3%.

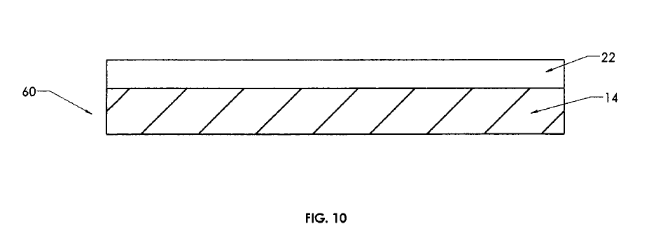

FIG. 10 is a cross sectional view of an alternative embodiment of an electrically conductive mat according to the present invention. FIG. 10 shows a mat 60 comprised of a rubber base 14 with a loading of carbon nanotube of between 0.1% and 10%. More specifically, base 14 is fabricated of an electrically conductive elastomer comprised of a base liquid silicone rubber with a loading of multi-walled carbon nanotubes of between 0.1% and 3%. Top coat 22 is a thermal plastic member affixed to base 14. Examples of a thermal plastic member may be a fluoropolymer, such as PFA, FEP, and PTFE.

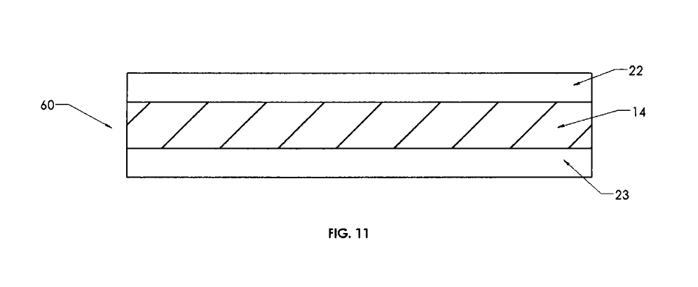

FIG. 11 is a cross section view of yet another alternative embodiment of an electrically conductive mat according to the present invention. FIG. 11 shows a mat 60 comprised of a rubber base 14 with a loading of carbon nanotube of between 0.1% and 10%. More specifically, base 14 is fabricated of an electrically conductive elastomer comprised of a base liquid silicone rubber with a loading of multi-walled carbon nanotubes of between 0.1% and 3%. Top coat 22 is a thermal plastic member affixed to base 14. Examples of a thermal plastic member may be a fluoropolymer, such as PFA, FEP, and PTFE. Bottom coat 23 is a metal to which base 14 is affixed.

1. A roller comprising an elastomeric carbon nanotube composite polymer having a loading, by Weight of between 0.1% to 10% carbon nanotubes and having an electrical resistivity value of 10¹² Ωcm through 10⁻¹ Ωcm or less.

2. The roller of claim 1 wherein the carbon nanotube composite polymer is comprised of single-walled carbon nanotubes to infer electrical conductivity to the polymer.

3. The roller of claim 1 wherein the carbon nanotube composite polymer is comprised of multi-walled carbon nanotubes to infer electrical conductivity to the polymer.

4. The roller of claim 1, wherein the carbon nanotube composite is fabricated from a material chosen from an elastomeric polymer of silicone, EPDM, FKM, or urethane.

5. The roller of claim 1, wherein the carbon nanotube composite is fabricated from a material chosen from liquid silicone platinum cured rubber, a high consistency rubber or a room temperature vulcanized silicone rubber.

6. The roller of claim 1, wherein the roller is fabricated from multi-walled carbon nanotube platinum cured liquid silicone composite polymer having a loading, by weight, of between 0.1% to 3% carbon nanotubes and having an electrical resistivity value of 10¹² Ωcm through 10⁻¹ Ωcm or less.

7. The roller of claim 6, further comprising a thermal plastic member fabricated from the group consisting of PFA, FEP, PTFE, Polyimide and Kapton.

8. The roller of claim 7, wherein the carbon nanotube is affixed to the thermal plastic member.

9. The roller of claim 8, wherein the thermal plastic member has an electrical resistivity that is no greater than the electrical resistivity of the carbon nanotube platinum cured liquid silicone composite polymer.

10. The roller of claim 8, wherein the thermal plastic member has an electrical resistivity that is greater than the electrical resistivity of the carbon nanotube platinum cured liquid silicone composite polymer.

11. A roller having a core and a base, the base having a inside diameter and an outside diameter, wherein the inside diameter is molded about the core, the base is fabricated of an elastomeric carbon nanotube composite rubber having an electrical resistivity value of 10¹²Ωcm through 10⁻¹ Ωcm or less.

12. The roller of claim 11, further comprising a top coat disposed about the entire outside diameter, wherein the top coat is fabricated of fluoropolymer having an electrical resistance that is not greater than the electrical resistance of the carbon nanotube composite rubber.

13. The roller of claim 11, further comprising a top coat disposed about the entire outside diameter, wherein the top coat is fabricated of fluoropolymer having an electrical resistance that is greater than the electrical resistance of the carbon nanotube composite rubber.

14. The roller of claim 12, wherein the carbon nanotube composite is selected from a material consisting of liquid silicone platinum cured rubber, a peroxide heat cured rubber, or a room temperature vulcanized silicone rubber.

15. The roller of claim 11, further comprising a thermal plastic member affixed to the nanotube composite rubber, wherein the thermal plastic member is fabricated of a material selected from the group consisting of PFA, FEP, PTFE, Polyimide, and Kapton.

16. The roller of claim 15, wherein the thermal plastic member has an electrical resistivity of no greater than the electrical resistivity of the nanotube composite rubber.

17. The roller of claim 15, wherein the thermal plastic member has an electrical resistivity of greater than the electrical resistivity of the nanotube composite rubber.

18. The roller of claim 11, wherein the core has an electrical resistivity of no greater than the electrical resistivity of the carbon nanotube composite rubber.

19. The roller of claim 11, wherein the core has an electrical resistivity of greater than the electrical resistivity of the carbon nanotube composite rubber.

20. A roller having a core and a base, the base having a inside diameter and an outside diameter, wherein the inside diameter is molded about the core, the base is fabricated of an elastomeric carbon nanotube composite rubber having an electrical resistivity value of 10¹² Ωcm through 10⁻¹ Ωcm or less; a top coat is disposed about the entire outside diameter, wherein the top coat is fabricated of fluoropolymer having an electrical resistance that is not greater than the electrical resistance of the carbon nanotube composite rubber; a thermal plastic member is affixed to the nanotube composite rubber, wherein the thermal plastic member is fabricated of a material selected from the group consisting of PFA, FEP, PTFE, Polyimide, and Kapton, wherein the thermal plastic member has an electrical resistivity of no greater than the electrical resistivity of the nanotube composite rubber, wherein the core has an electrical resistivity of no greater than the electrical resistivity of the carbon nanotube composite rubber, wherein the core is selected from the group consisting of aluminum, copper or steel.
